(19) United States
(12) Patent Application Publication
(10) Pub. No.: US 2004/0133463 A1
(43) Pub. Date: Jul. 8, 2004

(54) On-line survey method

(76) Inventor: Theodore Benderev, Laguna Hills, CA (US)

Correspondence Address: STETINA BRUNDA GARRED & BRUCKER, 75 ENTERPRISE, SUITE 250, ALISO VIEJO, CA, 92656, US

(21) Appl. No.: 10/680,028

(22) Filed: Oct. 7, 2003

Related U.S. Application Data
(63) Continuation-in-part of application No. 09/519,176, filed on Mar. 6, 2000, now abandoned.

(51) Int. Cl. G06F 17/60

(52) U.S. Cl. 705/10; 705/14

(57) ABSTRACT

On-line survey method. According to a preferred embodiment, a communication link is established to a target individual, typically through a personal computer via e-mail or a website, and information is obtained from the individual indicative of the individual's identity, as well as whether or not the individual fits a particular profile. To the extent the individual meets a requisite profile, the individual is provided with a contract wherein such individual, upon completing a survey or questionnaire, is in turn provided with an incentive. The individual is then given a limited amount of time to complete and return the survey via the communication link. The survey is then reviewed for completeness and, to the extent certain threshold criteria is met, the incentive is then provided to the individuals. The systems and methods of the present invention may be utilized for a variety of surveying applications, and are particularly useful in deriving comparative statistical data related to patient outcomes or patient satisfaction based upon shared assessments of a specific medical procedure, physician, or medical facility and fee cost associated therewith.

### CROSS-REFERENCE TO RELATED APPLICATIONS

The present application is a continuation-in-part of U.S. patent application Ser. No. 09/519,176, filed Mar. 6, 2000 entitled ON-LINE SURVEY METHOD. The present application further relies upon and incorporates by reference the teachings of Applicant's pending U.S. patent application Ser. No. 10/152,230, filed May 2, 2002, entitled ON-LINE PROMOTION METHOD.

### STATEMENT RE: FEDERALLY SPONSORED RESEARCH/DEVELOPMENT

Not Applicable

### BACKGROUND OF THE INVENTION

Among the most elusive tasks in marketing and surveying is obtaining useable survey data for use in targeting potential customers, measuring consumer satisfaction, and evaluating the performance and effectiveness of goods and services. Under conventional practices, such survey data is typically derived through questionnaires, interviews, and the like that have been directed toward a sample or a group of individuals believed to belong in the most relevant segment of the population.

Such traditional approaches, however, are known to have several significant drawbacks. As is known, considerable effort is required to actively seek out and obtain the sought-after information from an appropriate sample of individuals from a target population. In this respect, substantial effort must be made to ensure that the surveyed individuals are, in fact, representative of the target population of interest. Likewise, drawbacks are frequently encountered in obtaining meaningful responses to surveys, interviews, or questionnaires insofar as the same are viewed as time consuming and intrusive. Moreover, even to the extent a representative sample of surveys can be obtained, there is a substantial cost that is associated with such activities. For example, such prior art surveying methods typically involve the use of printed questionnaires that must be disseminated, typically through the mail, which further causes postal fees to be incurred. Similarly, conventional interviewing is labor intensive insofar as the same requires the interviewer to seek out and conduct such interviews, typically via telephone, which likewise involves further expense.

Recently, attempts have been made to utilize the Internet to gather data, opinions, etc. for purposes of generating ratings or conducting poles. Exemplary of such efforts include Epinions.com, maintained by Epinions, Inc., which purportedly offers unbiased advise based on a variety of subjects, and in particular goods and services, to enable consumers to make more informed buying decisions. To induce individuals to provide the data or opinions necessary to maintain such references, such website utilizes cash incentives paid to members subscribed to such a service. Unfortunately, such system encourages individuals motivated to participate whom are interested more into cash incentives, as opposed to providing meaningful feedback. Moreover, such framework does not selectively target those individuals fitting a certain profile, as may be necessary to effectively target and obtain meaningful feedback a statistical sampling from a desired population.

Also exemplary of prior art survey techniques include those utilized by Valuestar, Corporation, of Oakland, Calif., through its website Valuestar.com. Such website, which focuses on evaluating customer satisfaction, targets local service businesses and generates revenues by conducting customer satisfaction research in a variety of industries. The result of such data are compiled in a ratings scheme that consumers can utilize in making buying decisions. Such techniques, however, suffer from the drawback of failing to provide an incentive that not only provides a motivation for encouraging individuals to supply survey information, opinions, and the like but likewise fails to provide any incentive or motivation to further compel consumers to utilize a particular vendor of goods and services beyond the generation of favorable ratings or reviews. In essence, such prior art techniques are nothing more than conventional ratings systems.

While the foregoing drawbacks are well-known and associated with all forms of surveying, such drawbacks are particularly pronounced in a field of medicine in assessing patient outcomes. In this regard, the outcome of a given medical procedure, whether it be elective or non-elective, is typically determined on a case-by-case basis with each patient being assessed by his or her physician. Indeed, but for statistical data compiled by academic institutions for publication in the scientific literature, rarely is there any type of surveying system or method that enables patient outcomes or patient satisfaction to be quantitatively measured and updated on a continuous basis which can serve as a basis for evaluating whether or not a given procedure is optimal in certain circumstances.

Rarer still is survey evidence that provides statistical information regarding patient outcome/patient satisfaction that is determined on a physician-by-physician basis, a hospital-by-hospital basis or even by insurance carrier. In this respect, the patient who is given a choice of surgery typically has no system by which he or she can evaluate which physician in a given area has achieved the highest success rate in terms of patient outcome and patient satisfaction, as well as which hospital or medical facility in a given area is considered to produce more favorable outcomes. Indeed, prospective patients have little information regarding fees charged for services, billing practices, and other pertinent information crucial to making health care decisions. As such, patients are often relegated to making choices based upon very limited amounts of information, and are thus at the mercy of what are oftentimes uneducated guesses involving complex subject matter. The difficulty in making such choices by patients is further compounded by the ever-increasing availability of a greater variety of elective surgical procedures, including but not limited to cosmetic surgery, such as liposuction, and lasik surgery to correct vision.

While attempts have been made via the Internet to compile information directed to various physicians, hospitals, medical procedures, and the like, the Internet has such available information still does not address the foregoing concerns. In this regard, numerous websites are now maintained by physicians, medical groups, hospitals, health maintenance organizations, and the like that can enable potential consumers (i.e., patients) to review and obtain detailed specific information regarding a given medical procedure, physician or facility. Exemplary of such attempts include those made by Healthpages, LLC, via its website thehealthpages.com, which operates as a directory to enable potential patients to obtain information as to which physicians are available in a given geographic location that meets certain criteria, such as board certification, gender, years in practice, and manage care plan affiliations.

However, such information is typically in the form of promotions and advertisement which does not provide an objective basis by which a given physician/medical facility may be objectively evaluated. Rather, the information available via the Internet is no better than conventional advertising practices that, rather than providing useable statistical data to objectively evaluate a physician, medical institution or the likelihood of successful and satisfactory patient outcome based upon a given procedure, are focused on promoting a “sales pitch”.

Accordingly, there is a substantial need in the art for a surveying method that is more efficient and effective in collecting usable survey samples and compiling statistical information than prior art surveying methods. There is additionally a substantial need in the art for a surveying method that provides greater verifiability of statistical data than prior art methods. Still further, there is a need in the art for a surveying method that can be utilized to evaluate virtually any type of product or service, and is particularly well-suited for providing comparative data indicative of patient outcomes or patient as assessed by medical procedure, physician, hospital/medical institution, and/or insurance carrier.

### BRIEF SUMMARY OF THE INVENTION

The present invention specifically addresses and alleviates the above-identified deficiencies in the art. In this regard, the present invention is directed to an on-line surveying method that is more effective and efficient than prior art surveying techniques, and is further capable of generating survey results that are more accurate, comprehensive, and verifiable than prior art techniques. Still further, the on-line surveying method of the present invention can be utilized to obtain survey data for virtually any type of situation or application.

According to a preferred embodiment, the invention comprises establishing a communication link with a target individual believed to fit a desired profile of a target population. Preferably, such communication link may be established via an e-mail communication or by directing such prospective target individual to access a specified website. Once the communication link has been established, an invitation to the individual is preferably made, via the communication link, for the individual to disclose information concerning the individual's identity and background to determine whether the individual meets certain threshold criteria which may be necessary to properly ascertain whether or not such individual meets the desired profile for a given survey. Moreover, such information concerning the individual's identity will further preferably be screened to determine whether certain threshold criteria is met with respect to completeness, accuracy, and/or verifiability, as may be necessary in further aspects of the invention to ensure survey accuracy and integrity.

Upon submission of such identity and background information, and assuming such individual meets requisite criteria for a given survey, the individual is then provided with a contract whereby the individual, in return for completing the survey, is provided with an incentive. With respect to the latter, such incentive may take any of a variety of forms, including but not limited to, cash payments, discounts for goods and services, gifts, charitable donations, etc. Such incentive may further take any of those promotional techniques disclosed in Applicant's co-pending U.S. patent application Ser. No. 10/152,230, filed May 2, 2002, entitled ON-LINE PROMOTIONAL METHOD, the teachings of which are expressly incorporated herein by reference. To the extent the individual enters into such contract, the individual is then provided with the relevant survey. As per conventional surveying techniques, such survey may comprise a questionnaire or other similar type of survey item. Alternatively, the survey may comprise a scheduled interview or other procedure through which the sought after information may be obtained. Thereafter, the individual will complete such survey, interview, etc., and where applicable, retransmit the same via the communication link to the desired e-mail address or website. In order to ensure timely completion of any type of forwarded questionnaire or survey, the individual may be obligated to return the same within a fixed period of time, which may range anywhere from a few minutes to seventy-two hours (72 hrs.), or possibly longer, depending on the circumstances. Assuming the survey or questionnaire provided to the individual meets certain threshold levels regarding completeness, and hence is usable, the individual is then forwarded the incentive called for in the contract.

The data derived by the on-line surveying methods of the present invention may thereafter be utilized for any of a variety of applications. In this respect, the data may be utilized to evaluate customer satisfaction, product evaluation, price comparison, or simply for gathering opinion data or demographic information the generated data may further be specific to particular group, such as professionals (e.g., accountants, attorneys, etc.) for use in the evaluation of peers and the like. Still further, it is contemplated that the data may be utilized for advertising marketing purposes to enable sellers to more selectively target their marketing efforts based upon feedback provided by those surveyed. Still further, it is contemplated that the data generated by the systems and methods of the present invention can be utilized as a general database that may be accessed by potential consumers to obtain comparative information, from people who match similar demographics or otherwise, on products and services offered by a variety of competitors. Moreover, it is believed that the on-line survey methods of the present invention are particularly well-suited for offering a patient or potential surgical candidate a quantitative analysis indicative of potential patient outcomes and patient satisfaction based upon procedure, physician, and/or health care facility (e.g., hospital, out-patient surgery, etc.). In this respect, it is believed that the on-line surveying methods of the present invention may advantageously provide means for a patient to obtain an educated basis as to what type of procedure, physician and/or medical facility is deemed most optimal for treating a given condition in a given locality.

It is therefore an object of the present invention is to provide an on-line surveying method that is more efficient and effective in conducting surveys, generating survey results, and survey responses than prior art techniques.

Another object of the present invention is to provide an on-line surveying method that enables surveys to be conducted in a manner that is far more cost effective and less labor intensive than prior art techniques.

Another object of the present invention to provide an on-line surveying method that can be utilized to compile survey data for virtually any type of purpose, including but not limited to, product and service evaluation, customer satisfaction, or public opinion.

Another object of the present invention to provide an on-line surveying method that can provide comparative information directed to predicting a patient outcome and/or patient satisfaction based upon the type of medical procedure performed, the physician performing such procedure, and the hospital medical facility in which such procedure may be performed.

Still further objects of the present invention are to provide an on-line surveying method that is simple to deploy, easy to utilize, may be readily implemented utilizing existing technology, can ensure privacy, and can provide greater accuracy and verifiability than prior art surveying methods.

### BRIEF DESCRIPTION OF THE DRAWINGS

These, as well as other features of the present invention, will become more apparent upon reference to the drawings, wherein:

FIG. 1 is a flow chart illustrating operation of the on-line surveying method according to a preferred embodiment of the present invention.

### DETAILED DESCRIPTION OF THE INVENTION

The detailed description set forth below in connection with the appended drawing is intended merely as a description of the presently preferred embodiment of the invention, and is not intended to represent the only form in which the present invention may be constructed or utilized. Description sets forth the functions and sequence of steps for constructing and implementing the invention in connection with the illustrated embodiment. It is to be understood, however, that the same or equivalent functions and sequences may be accomplished by different embodiments that are also intended to be encompassed within the spirit and scope of the invention.

With respect to the present invention, there is provided a system and method for conducting on-line surveys over a computer network, namely, the Internet. As appreciated by millions, the Internet is a system of linked computers that permit fast, low-cost global communication, entertainment, and information exchange, and hence is the primary vehicle by which the methods of the present invention may be practiced. As such, the Internet, through interface between servers and personal computers, thus advantageously serves as a primary contact medium by which the surveys of the present invention may be conducted. However, while the present invention as described herein is embodied in such network (i.e., the Internet), it should be understood that the invention is not limited in this respect, and may be embodied in any data communications system wherein a system requests data from a client, via a content server, and thus may include, but by no means limited to on-line information services, telephone networks, and television networks.

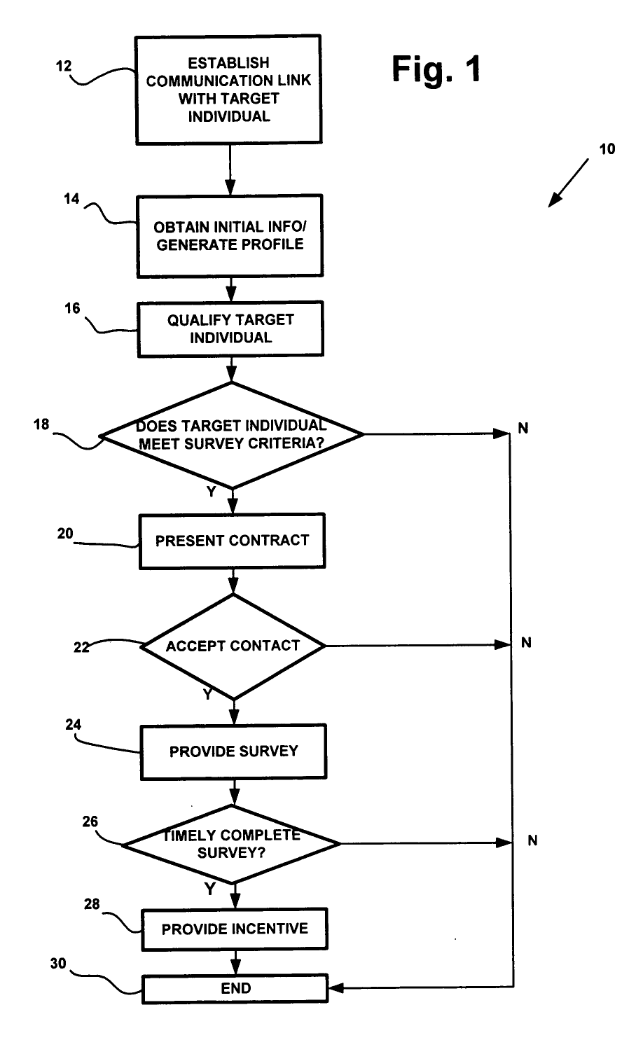

Referring now to FIG. 1, there is shown a flow chart depicting the various steps comprising the on-line survey method 10 of the present invention. As illustrated, the on-line survey method 10 comprises the initial step 12 of establishing a communication link with a target individual or client sought to be surveyed. Typically, such communication link will be established through a personal computer via the Internet. In this respect, the target individual may be contacted through conventional communication modalities, such as electronic mail (i.e., e-mail), or alternatively, the targeted individual may access an authorized website conforming to the principals of the invention as more fully stated herein.

Once the communication link has been established with a targeted individual, certain information may be requested from the individual regarding the individual's identity, and may include information concerning the individual's name, telephone number, mailing address, and/or electronic mail address. Moreover, to the extent it is essential to obtain further detailed information, as may be necessary to determine whether or not the targeted individual is deemed to have a desirable profile for a given survey, additional information may be requested from the individual regarding individuals' age, race, state of health, occupation, sex, residential zip code, household income, etc. or other potentially useful information specific as to the particular demographics within which the targeted individual may be characterized.

Based upon the information obtained from the target individual, an optional determination may be made as to whether or not the target individual meets the criteria for a given survey using conventional practices known in the art. In this respect, it is contemplated that a screening step may be provided which will determine, based upon the information obtained from the targeted individual, whether or not to terminate the session, or else proceed with the surveying process. For example, to the extent a particular survey to be conducted through the methods of the present invention involves preferred features for automobiles, those individuals not of driving age will not be of interest and thus may be excluded from participating in a given survey. Similarly, to the extent the surveys are utilized to assess and evaluate consumer satisfaction (e.g., consumers that have previously purchased a particular make and model of a vehicle or patients that have previously undergone a particular procedure) only those actual consumers would be deemed appropriate candidates. As will be recognized by those skilled in the art, safeguards may be provided to ensure that such contact information is verifiable (e.g., by providing access codes to the targeted individuals, etc.) and further, that the contact information of each target individual is kept confidential.

To the extent a targeted individual provides useable identification data and profile criteria sufficient to one participation in a given survey, the targeted individual is then presented with a contract. Such contract, which may take any of a variety of forms, provides an incentive to the targeted individual in return for completing a given survey. In this respect, it is contemplated that such contracts may be deployed as per conventional click agreements or click-rap agreements well known extensively utilized in the art. Additionally, the various contracts utilized in the practice of the present invention may take on any degree of formality as may be applicable for a given situation.

Preferably, the contract will inform the targeted individual of the nature of the survey or a questionnaire that the targeted individual will be obligated to complete, as well as the details of the incentive to be provided in return. As will be recognized by those skilled in the art, the incentive provided through the methods of the present invention can take any of a variety of forms, including but not limited to cash payments, discounts on goods and services, gifts (e.g., as may be selected from a catalog or library), charitable contributions, entry to a contest, credits towards future purchaser, or any of a variety of other types of consideration or recognition. Along these lines, it is expressly contemplated that such incentives may take any of those disclosed in Applicant's co-pending U.S. patent application Ser. No. 10/152,230, filed May 2, 2002, entitled ON-LINE PROMOTION METHOD, the teachings of which are expressly incorporated herein by reference.

Such contract will further preferably place obligations to the targeted individual to complete any type of survey or questionnaire provided, whether written or otherwise, as well as an obligation to timely complete the same. With respect to the latter, it will be recognized that survey participants may be given a limited amount of time, which may vary depending on application (e.g., from a few minutes to seventy-two hours), after which time failure to complete such survey terminates the contract and provides the targeted individual with no bargained for incentive. Still further, obligations may be placed on a targeted individual that she or he has provided or will provide answers to such survey questionnaires, under oath, that are as full, complete, and true. The contract will further provide for additional terms and provisions as may be necessary for a given situation, as well as comply with all applicable state and federal law.

Upon acceptance by the targeted individual of the terms of the contract, as communicated over the communication link, the targeted individual is then provided with the survey or questionnaire. As per conventional surveying practices, the survey or questionnaire provided to the targeted individual may take any of a variety of forms well-known to those skilled in the art. Alternatively, the methods of the present invention may be utilized to facilitate interview-type surveys whereby the targeted individual, by entering into the contractual agreement, commits to making herself or himself available for an interview at a specified time. Whether or not the targeted individual is to be provided with the incentive may be dependant upon the timeliness and completeness or the answers provided through such scheduled interview.

Depending upon whether or not the targeted individual has provided sufficiently complete responses to the survey, and further, that the targeted individual verifies the accuracy of the answers provided thereto, the incentive is then dispersed to the targeted individual. As discussed above, the incentive may take any of a variety of forms and may be conveyed to the targeted individual via a multiplicity of mediums, whether by the surveyor or a third-party vendor. In this respect, gift incentives, cash payments, or discounts may be shipped or mailed, or otherwise transferred on-line over the communication link.

Along these lines, and as per the teachings of Applicant's co-pending U.S. patent application Ser. No. 10/152,230, such incentive may further be accompanied by advertising or promotional material that may include information as to any helpful information, additional advertising materials, and the like may be sponsored by the surveyor or a third-party vendor in order to entice the targeted individual to enter into a transaction with the surveyor or third-party vendor. Such advertising may further be generated in response to one or more of the answers posted in response to such survey through techniques well known in the art. For example, advertisements for businesses in a given locale may be generated and forwarded to survey participants located within a specific ZIP code. In any event, in the preferred embodiment a transaction record will be generated that documents dispersement of such incentive to thus ensure compliance with the contractual obligations between the surveying entity and the targeted individual.

Advantageously, the on-line survey methods of the present invention are thus able to directly access a considerable segment of the population at an extremely low cost. Likewise, the methods of the present invention provide for further safeguards, such as verifiability of a surveyed entity's identification, as well as completeness and accuracy of such surveyed entity's responses to the provided survey, questionnaire and/or interview than prior art surveying techniques which rely upon the information that is purely volunteered and provides no safeguards for ensuring the targeted identities' profile, and whether or not the same is commensurate with data sought from a target segment of the population. As will be recognized, however, in order to accurately assess the results generated by the survey methods of the present invention, it may be necessary to statistically adjust such data based upon the fact that the targeted individuals will apparently have access to computer systems, namely personal computers, which may thus statistically deviate from the relevant populations sought to be surveyed.

In addition to the novel approach of generating survey data, the present invention further comprises utilization of such data for purposes directed to the advertising and promotion of goods and services. In this respect, by providing the contracted-for-incentive, such incentive may be tied to rebates or coupons to thus offset the costs of past or future purchases by consumers. More specifically, it is contemplated that the data generated through the on-line surveying methods of the present invention may be compiled, tabulated and maintained through a website accessible to consumers such that such consumers can review the results of one or more surveys. Moreover, the website may be utilized to entice potential consumers to participate in one or more surveys by providing an incentive that directs consumers toward a particular vendor (i.e., to the extent a potential customer completes an on-line survey, the consumer will receive an incentive that may direct the consumer to purchase a particular item from a particular vendor at a particular location).

For example, to the extent a potential customer is interested in purchasing a vehicle, the information regarding the potential customer's geographic whereabouts (e.g., as may be determined from a zip code), coupled with a particular make and model of the car of interest, may thus consequently cause an incentive to be issued that directs the individual to purchase the desired vehicle from a particular dealer within the desired geographic location. Moreover, it is contemplated that statistical data compiled from previous consumers may be utilized as a reference from which potential customers may determine which particular vendor and which particular geographic location best suits the potential consumer's needs. Still further, to the extent the on-line surveying methods have generated data regarding consumer satisfaction from a particular vendor, coupled with other important information regarding the vendor, such as pricing policies, warranties, etc., such statistical data may thus be utilized to provide an objective basis for causing the potential consumer to select a particular vendor.

As will be recognized by those skilled in the art, the on-line surveying methods of the present invention may be utilized for virtually any purpose. In this respect, it is believed that the surveying methods may be utilized for the general population, or any specific segment thereof. In this respect, it is contemplated that the surveying methods may be utilized by certain groups, and more specifically, professionals (e.g., accountants, attorneys, certified public accountants, etc.) for use in peer evaluation, quality-control, and competitive pricing. Along these lines, it is contemplated that surveying methods may be utilized to facilitate competition between businesses by providing a readily available means for gaging competition for goods and services in a particular market.

In one particular aspect of the present invention, however, it is believed that the on-line surveying methods of the present invention are particularly well-suited in the assessment of patient outcomes and patient satisfaction following a given medical procedure. In this respect, it is well-recognized in the art that clinical data indicative of a particular patient outcome is generally limited to academic settings, and typically for publication in the scientific literature. Rarely is any type of ongoing monitoring of patient outcomes or patient satisfaction maintained for routine medical and surgical procedures performed outside the academic environment.

Moreover, in light of the ever-increasing number of elective medical procedures that are performed, such as liposuction, orthodontics, vasectomies, or lasik vision correction procedures, there is little, if any, comparative data as to whether the patient will have a greater likelihood of experiencing a successful outcome based upon the patient's selection of physician or medical facility. Generally, there is typically no comparative data as to which physicians in a given area are statistically proven to produce more favorable patient outcomes and patient satisfaction than others based on a shared assessment of outcome. This lack of data further applies to medical facilities that may based in a given area, which thus leads potential patients having to oftentimes guess whether or not a given procedure should be performed, let alone by which particular physician at which medical facility a given vicinity has to offer.

To address such situations, the on-line surveying methods of the present invention will not only generate statistical data indicative of the probability of successful patient outcomes, but can further provide comparative data as to which physicians tend to produce a greater probability of a successful outcome. Along these lines, it is believed that not only will such data as derived by the methods of the present invention prove to “sell” potential consumers/patients to a particular physician or medical facility, but when coupled with the incentive provided as part of participating in a relevant survey, will provide yet further motivation to have a given procedure performed by such physician at the particular medical facility.

In this regard, it is contemplated that based upon the statistical information generated by the surveying methods of the present invention, the potential consumer/patient may be provided with an extensive database by which he or she may make informed decisions as to which should perform which procedure at which medical facility. For example, a prospective patient faced with having to undergo open-heart surgery may thus be able to determine which surgeons in a given vicinity have performed the most surgeries, and what outcomes of those surgeries were. Likewise, such prospective patient can determine which medical facility to have such procedure performed by determining which facility has produced the most successful outcomes.

Along these lines, it is expressly contemplated that the survey method of the present invention are particularly well suited to assess professional health care services rendered into the aforementioned specific procedures related to cosmetic surgery, lasik vision correction, orthodontics, and, most especially, vasectomies. In this regard, many of the principles behind the present invention are exemplified in Applicant's web site, www.vasectomy.com, the teachings and disclosure of which are expressly incorporated herein by reference. Specifically, it is contemplated that such database can provide consumers with information regarding the various health care providers rendering such services, and can include information such as the type of insurance that is accepted, the credentials of such health care providers or any specialized training the health care provider may have received, office hours, office location, patient experiences with such procedures and the like.

In addition to prospective patients, it will be understood that the data derived by the methods of the present invention will further be useful to insurance companies, health maintenance organizations, and other entities having invested interest in providing optimal health care. Furthermore, it is contemplated that the data compiled through the methods of the present invention, particularly with respect to health care, may be sold as valuable marketing information to such interested parties.

Given the widespread applicability of the methods of the present invention, it is believed that such novel methods may be utilized in a variety of contexts. In this respect, it is contemplated that the on-line survey methods may be incorporated into search engines to direct potential customers to particular vendors offering specified benefits, such as hotel operators achieving higher ratings and politeness of staff, and airlines having the best records for on-time departures. Still further, it is believed that the methods of the present invention may be deployed and administered over fixed geographic areas that direct potential consumers to local businesses (e.g., car dealerships, hospitals, accountants, exterminators, etc.) located within such fixed geographic areas. In such context, it is believed that such surveying systems may be administered via a franchise arrangement such that the ongoing generation and computation of statistical data regarding customer evaluation of a variety of vendors and service providers for a given area is continuously updated.

Still further, it is contemplated that the methods of the present invention may be practiced in either a profit or non-profit context. In this respect, the on-line surveying methods of the present invention may be tabulated and made publically available as a public service (e.g., evaluating education methods and student progress) or utilized through conventional on-line marketing practices. With respect to the latter, it is contemplated that websites utilizing the methods herein may incorporate revenue-generating practices, such as banner advertising and like. Moreover, it is contemplated that further revenue may be generated to the extent sales are generated for a particular vendor, and further, that such vendor may be responsible for deferring the costs associated with providing incentives necessary to implement the methods of the present invention.

Although the invention has been described herein with specific reference to a presently preferred embodiment thereof, it is to be further understood that various additions, deletions, modifications and alterations may be made to the above-described embodiments without departing from the intended spirit and scope of the present invention. Accordingly, it is intended that all such additions, deletions, modifications and alterations be included within the scope of the following claims.

What is claimed is:

1. (Original) A method for conducting a survey with a target individual related to a medical procedure experienced by said individual, wherein said survey is conducted over at least one computer network wherein said network connects at least one personal computer associated with said target individual to at least one information-provider computer, the method comprising the steps:
a) establishing a communication link between said at least one personal computer associated with said target individual to said at least one information-provider computer over said network;
b) providing a contract to said target individual via said at least one personal computer over said network, said contract providing an offer to provide said target individual with an incentive for completing said survey, wherein said survey is directed to the evaluation of the performance of a medical procedure experienced by said individual, said procedure being selected from the group consisting of liposuction, lasik vision correction, and vasectomy performed in an outpatient medical facility by a health care provider on said target individual;
c) confirming acceptance by said target individual of said contract provided for in step b);
d) providing said target individual with said survey;
e) receiving answers to said questionnaire from said target individual in response to said survey provided for in step b);
f) providing said target individual with said incentive contracted for in step c); and
g) generating advertising materials and displaying said advertising materials across said network to said personal computer, said advertising materials being generated based upon said answers received in step e).

2. (Original) The method of claim 1 wherein said evaluation comprises obtaining data regarding the target individual's results with the outcome of said medical procedure.

3. (Original) The method of claim 1 wherein said evaluation comprises obtaining data regarding the target individual's satisfaction with the outpatient medical facility within which said procedure was performed.

4. (Original) The method of claim 1 wherein said evaluation comprises obtaining data regarding the target individual's satisfaction with the health care provider responsible for having performed said medical procedure on said target individual.

5. (Original) The method of claim 1 wherein said method further comprises:
a) repeating steps a) through h) such that multiple responses are gathered from a multiplicity of target individuals;
b) statistically analyzing said multiplicity of responses from said multiplicity of target individuals to derive statistical findings; and
c) publishing said statistical findings.

6. (Original) The method of claim 5 wherein said statistical findings are published via a website accessible over a global communications network.

7. (Original) The method of claim 1 wherein following step a) and prior to step b), said method further comprises the steps:
a) gathering personal data of said target individual and generating a profile for said target individual;
b) qualifying said target individual using said profile to participate in a survey.

8. (Original) The method of claim 5 wherein said step of statistically analyzing said multiplicity of responses from said multiplicity of target individuals to derive statistical findings further comprises deriving statistical findings based upon the demographics of said target individuals, and said step of publishing said statistical findings further comprises publishing said statistical findings based upon said demographics of said target individuals.

9. (Original) The method of claim 8 wherein said demographics of said target individuals are selected from the group consisting of the age of said target individuals, the incomes of said target individuals, the sex of target individuals, the educational levels of said target individuals, the occupations of said target individuals, and the geographic residences of said target individuals.
